(19) United States
(12) Patent Application Publication
(10) Pub. No.: US 2004/0042894 A1
(43) Pub. Date: Mar. 4, 2004

(54) Wind-driven electrical power-generating device

(76) Inventor: J.C. Smith, Wicklow (IE)

Correspondence Address: BIRCH STEWART KOLASCH & BIRCH, PO BOX 747, FALLS CHURCH, VA, 22040-0747, US

(21) Appl. No.: 10/466,417

(22) PCT Filed: Jan. 17, 2001
(86) PCT No.: PCT/IE01/00009

(51) Int. Cl. F03D 7/02

(52) U.S. Cl. 415/4.3

(57) ABSTRACT

A wind-driven electrical power-generating device has a wind turbine (11) connected to an electrical generator (12), with both the wind turbine (11) and the generator (12) being mounted on a support structure (14) with freedom of movement through 360° in the horizontal plane such that, in use the wind turbine (11) locates downwind of the support structure (14) in a self-orientating manner. The wind turbine (11) is in the form of a housing (16) having an air intake (17) and an air outlet (19) and a plurality of turbine blades (21), located therebetween in the form of a ring (35). A recovery ring of turbine blades (48) is located aft of the turbine blade ring (35). Passage of air over a vortex generator (23), mounted on an outer surface (24) of the housing (16), results in the formation of a vortex downwind of the air outlet (19). This has the effect of lowering the air pressure immediately aft of the air outlet (19), which causes the speed of the airflow through the housing (16) to increase, resulting in an increase in power output.

### TECHNICAL FIELD

This invention relates to a wind-driven electrical power-generating device and to a wind turbine for use therewith.

### BACKGROUND ART

Small-scale wind-driven electrical power generating devices have been used for generations in remote areas not served by electricity utility companies. However, in more recent years, as the cost of fossil fuels, such as oil, has increased, more interest has been taken in alternative renewable sources of energy, such as tidal, hydroelectric and wind.

The design of wind-driven electrical power devices has not changed much over the years. Thus, the basic device involves a turbine, comprising a set of rotor blades, rather like an oversized aircraft propeller, connected to an electricity generator through a system of gears. Developers have mainly concentrated on improvements in the blades, the manufacturing process, production of larger turbines and in the reduction of maintenance requirements.

However, devices with large turbines must be mounted on tall and massive towers. These can spoil the landscape in which they are placed, which is usually in a remote area. In addition, since a number of devices must be located together to provide an economical energy output, the negative impact on the landscape is increased.

The size of the turbine and the mounting requirements limit the number of suitable site locations for the devices.

These large devices are very noisy, which is a consequence of the high gear ratio between the turbine and the generator.

The devices can only safely be operated in wind speeds up to approximately 80 kph. At speeds above this limit the device must be shut down to avoid damage. Shutdown is achieved by turning the turbine and generator broadside to the wind and holding them there. This positioning and holding in place relies on an azimuth motor referenced by a remote wind direction sensor. The azimuth motor is geared to a ring gear. Failure or malfunction of any of these key components will render the entire system inoperable, and such an occurrence could lead to more serious damage to the device, and could possibly result in the loss of the turbine.

As the size of the turbine is increased, to provide more power output, the support structure must also be enlarged and a point is reached where further enlargement of the turbine becomes uneconomical. The current devices have reached this limiting point of cost versus output.

It is an object of the present invention to overcome the disadvantages of the conventional wind-driven electrical power-generating device as described hereinbefore.

### DISCLOSURE OF INVENTION

Thus, the invention provides a wind-driven electrical power-generating device, comprising a wind turbine connected to an electrical generator, the wind turbine and generator each being mounted on a support structure, the wind turbine being in the form of a housing having an air intake at a front end and an air outlet at a rear end thereof, a plurality of turbine blades located, between the air intake and the air outlet, within the housing and fixed to an inner surface thereof, and a vortex generator arranged on an outer surface of the housing such that, in use, passage of air through the housing over the turbine blades causes the wind turbine to rotate and generate power, and such that passage of air over the vortex generator results in the generation of a vortex downwind of the air outlet.

The advantage of having the turbine blades enclosed within a housing is that more of the available wind is channelled over the blades resulting in increased power output relative to a conventional device of similar size.

The formation of a vortex (a rapidly spinning column of air) downwind of the air outlet causes a drop in air pressure immediately behind the air outlet. This area of reduced air pressure causes the speed of the airflow through the housing to be increased with a consequent increase in power output.

Preferably, the housing is in the form of a truncated cone, the base of which forms the rear end of the housing, and the vortex generator is a plurality of vanes mounted on the outer surface of the housing and set at an angle to the longitudinal axis thereof.

The arrangement of the vanes on the outer surface of the housing causes the air passing over them to form into a symmetrical vortex downwind of the air outlet.

Further, preferably, the outer surface of the cone adjoining the rear end of the housing is flared out to form an annular ring to which the ends of the vanes are attached.

The provision of a flared out annular ring causes the airflow around the housing to be slung outwards resulting in the formation of the vortex well behind the air outlet. This produces a significant drop in air pressure immediately behind the air outlet.

In one embodiment of the device in accordance with the invention, the turbine blades are arranged in a ring.

The advantage of having the turbine blades arranged in a ring is that a large number of blades can be employed with only small spaces therebetween, resulting in a large portion of the energy from the airflow being harnessed.

Suitably, the air intake is formed from the inner surface of the housing and a conical shaped disc, which is attached at its centre to a hub member and at its periphery to the turbine blade ring.

The airflow hitting the conically shaped disc is forced outwards towards the turbine ring with a consequential increase in the speed of the incoming air. This results in an increase in the pressure of the air reaching the turbine blades and therefore an increase in the pressure drop across the blades, with a resultant increase in power output.

Preferably, the air intake has a plurality of guide vanes mounted between the conical shaped disc and the inner surface of the housing to form separate intake sections.

An advantage of the plurality of guide vanes is that the airflow is guided through the air inlet towards the turbine blades.

A further advantage is that the vanes form part of the structure of the wind turbine and contribute to its overall strength.

Further, preferably, the guide vanes terminate short of the turbine blade ring to form an open annular normalising area.

The provision of an open annular normalising area allows the airflow to merge before passing over the turbine blades, resulting in a smoother operation of the device.

In a further embodiment of a device in accordance with the invention a recovery ring of turbine blades is mounted aft of the turbine blade ring.

The provision of a recovery ring of turbine blades increases the efficiency of the device, as further energy is extracted from the airflow as it passes over the recovery ring of turbine blades.

Preferably, the turbine blade ring and the recovery ring of turbine blades are separated by an annular chamber in which the airflow, in use, is marshalled prior to it passing through the recovery ring of turbine blades.

The annular chamber allows the airflow to merge again following passage through the turbine blades and redirects it for delivery to the recovery ring of turbine blades. This results in a device, which runs more smoothly.

In a further embodiment of a device in accordance with the invention, the wind turbine and the electrical generator are mounted on the support structure with freedom of movement through 360° in the horizontal plane, such that, in use, the wind turbine locates downwind of the support structure in a self-orientating manner.

The mounting of the wind turbine and generator in this fashion means that the wind turbine will always automatically face into the wind without the need for external control. This eliminates the danger of the device being damaged due to sudden changes in wind direction. It also increases the efficiency of the device.

In a still further embodiment of a device in accordance with the invention, the device has means for moving the wind turbine in and out of the airflow.

The ability to move the wind turbine in and out of the airflow means that the device may be operated in conditions where a conventional wind-driven electrical power-generating device would normally have to be closed down.

Preferably, the means for moving the wind turbine moves the turbine between a position where the turbine is fully into wind and the longitudinal axis of the turbine is parallel to the wind direction, and a position where the turbine is parked and the longitudinal axis of the turbine makes an angle of between 35-50° with the wind direction.

In normal operation, the wind turbine faces fully into the wind. However, in conditions where the wind speed is increasing, a wind speed will be reached above which it will be necessary to tilt the wind turbine progressively out of the wind. If the wind speed continues to increase the wind turbine will eventually reach the parked position where the airflow ceases to pass through the housing to provide power.

Suitably, the angle between the longitudinal axis of the turbine and the wind direction is 45°, when the turbine is in the parked position.

Preferably, the means for moving the wind turbine causes it to move in and out of the airflow in a vertical direction.

Suitably, the means to move the wind turbine is a hydraulic arm.

Preferably, the hydraulic arm is under computer control.

Further, preferably, the computer is linked to a wind speed sensor and a wind direction sensor, and wherein the hydraulic arm progressively moves the wind turbine towards the parked position as the wind speed increases above a safe level for operating the device in the fully into wind position.

The provision of a hydraulic arm under computer control, which is sensitive to changes in wind speed means that at any given time the maximum power is being derived from the airflow. At wind speeds above the speed at which the wind turbine starts to tilt out of the airflow, the degree of tilt at all times matches the speed of the wind.

Suitably, the computer further monitors functions of the device including generator output, hydraulic pressure, hydraulic fluid quantity, and oil quantity and pressure.

The various functions of the device are monitored by the computer and can be reviewed by a controller on the ground. At any time, the controller can instruct the computer to shut down the device by moving the wind turbine into the parked position.

Advantageously, the device has failsafe means for moving the wind turbine to the parked position in the event of a system failure.

Thus, independently of an instruction from a ground controller, the device will shut down in the event of a malfunction in one of the systems.

The failure can be in the hydraulic system. Alternatively, the failure can be in the computer.

Suitably, the failsafe means is a blow down backup pneumatic high-pressure cylinder, which, when activated, causes the hydraulic arm to move the wind turbine to the parked position.

In the event of a system failure, the pneumatic high-pressure cylinder discharges into the down chamber of the hydraulic arm causing the wind turbine to move to the parked position.

The invention also provides a wind turbine as hereinbefore described.

### BRIEF DESCRIPTION OF DRAWINGS

The invention will be further illustrated by the following description of an embodiment thereof, given by way of example only with reference to the accompanying drawings in which:

FIG. 1 is a side elevation of a device according to the invention, with the wind turbine in the fully into wind position;

FIG. 2 is a side elevation of the device of FIG. 1, with the wind turbine in the parked position;

FIG. 3 is a perspective view of the wind turbine of the device of FIG. 1;

FIG. 4 is a cutaway view of the wind turbine of FIG. 3;

FIG. 5 is a side elevation of the cutaway view of the wind turbine of FIG. 4; and

FIG. 6 is a perspective view of the turbine blade rings of the wind turbine of FIG. 3.

### BEST MODE FOR CARRYING OUT THE INVENTION

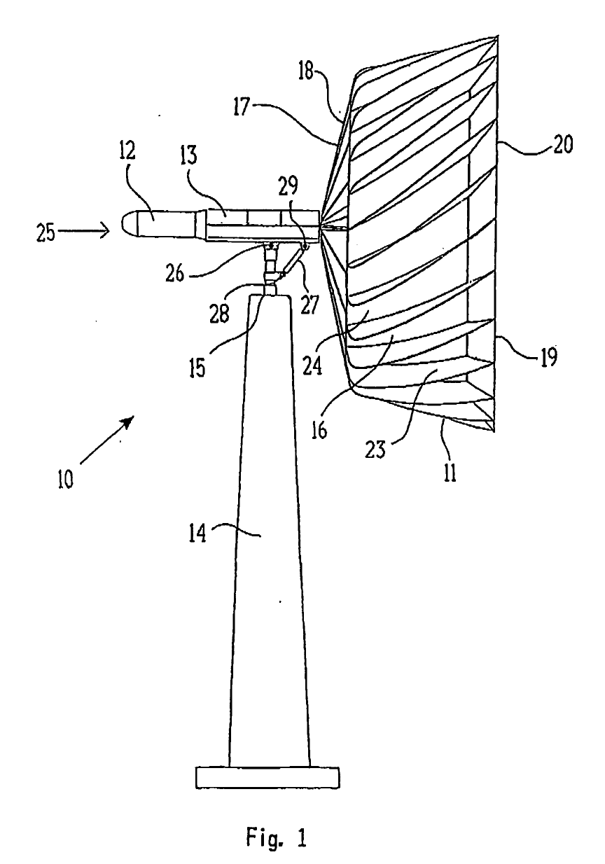

Referring to FIG. 1 there is illustrated generally at 10, a wind-driven electrical power-generating device having a wind turbine 11 connected to an electrical generator 12 through a superstructure 13, which houses such components as a carrier and thrust bearing enclosure, a braking assembly, a transmission gearbox, a hydraulic system, an onboard computer, and miscellaneous ancillary support items such as a battery (not shown). The wind turbine 11, the generator 12 and the superstructure unit 13 are mounted on a support structure 14, at position 15, with freedom of movement through 360° in the horizontal plane such that, in use, the wind turbine 11 locates downwind of the support structure 14 in a self-orientating manner.

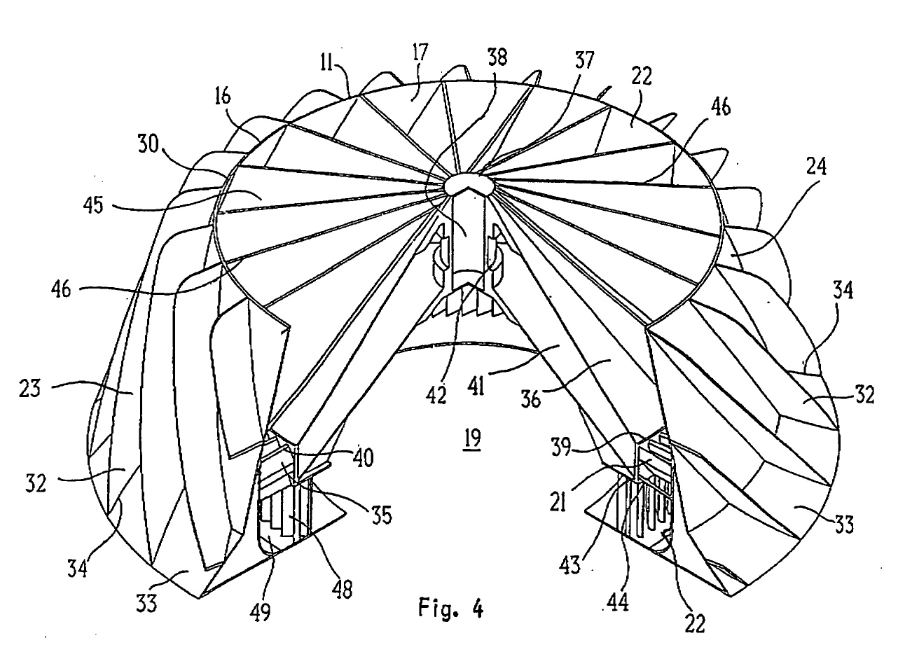

The wind turbine 11 is in the form of a housing 16 having an air intake 17 at the front end 18 and an air outlet 19 at the rear end 20 thereof A plurality of turbine blades 21 (FIG. 4) is located between the air intake 17 and the air outlet 19 of the housing 16 and is fixed to an inner surface 22 (FIG. 4) thereof. A vortex generator 23 is arranged on an outer surface 24 of the housing 16 such that, in use, passage of air through the housing 16 over the turbine blades 21 (FIG. 4) causes the wind turbine 11 to rotate and generate power, and such that passage of air over the vortex generator 23 results in the generation of a vortex downwind of the air outlet 19.

In FIG. 1 the device is illustrated with the wind turbine 11 in a fully into wind position. The wind direction is indicated by arrow 25. Thus, in this position, the longitudinal axis of the wind turbine 11 is parallel to the wind direction 25.

The wind turbine 11, the electrical generator 12 and the superstructure unit 13 are also pivotally mounted on the support structure 14 at position 26. A hydraulic arm 27 is connected to the support structure 14 at point 28 and to the superstructure unit 13 at point 29.

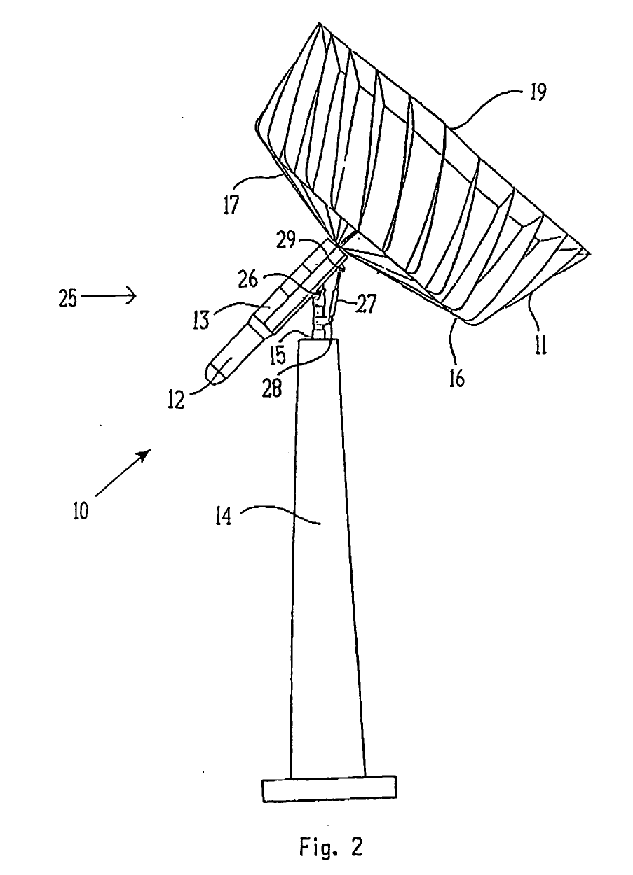

The wind turbine 11 will remain in the fully into wind position up to a speed beyond which the hydraulic arm 27 will extend and cause the wind turbine 11 to tilt out of the wind. As the wind speed continues to increase, the hydraulic arm 27 extends further until the wind turbine 11 reaches a parked position, as illustrated in FIG. 2. In the parked position, the longitudinal axis of the wind turbine 11 makes an angle of 45° with the wind direction 25.

Once the parked position has been reached the braking assembly (not shown), in the superstructure 13, may be activated to bring the wind turbine 11 to a halt.

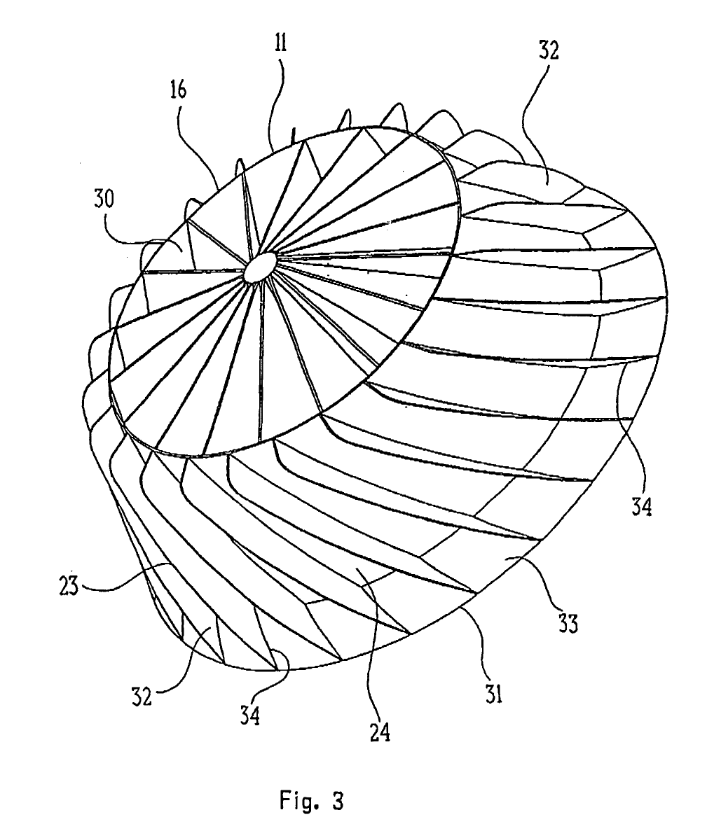

Referring to FIG. 3 the wind turbine 11 is illustrated in perspective. The principal components of the wind turbine 11 are fabricated from carbon fibre material, which has the characteristics of lightness coupled with strength. The housing 16 of the wind turbine 11 is in the form of a truncated cone 30, the base 31 of which forms the rear end 20 of the housing 16. The vortex generator 23 is a plurality of vanes 32 mounted on the outer surface 24 of the cone 30. The vanes 32 are set at an angle to the longitudinal axis of the wind turbine 11. The outer surface 24 of the cone 30 adjoining the rear end 31 of the housing 16 is flared out to form an annular ring 33 to which the ends 34 of the vanes 32 are attached.

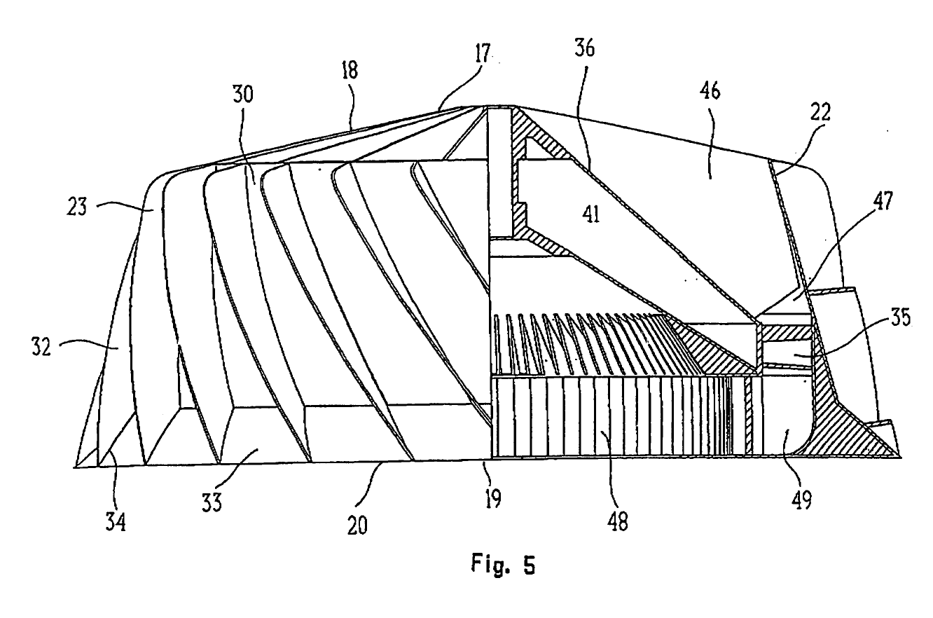

Referring to FIGS. 4 and 5 further details of the interior of the wind turbine 11 are illustrated. Thus, a plurality of turbine blades 21 is located between the air intake 17 and the air outlet 19 of the housing 16 and is fixed to the interior surface 22 thereof. The plurality of turbine blades 21 is arranged in a ring 35. The turbine blades 21 are airfoil shaped and are mounted in a fixed angle position such that the maximum energy can be extracted from the airflow through the housing 16. Each blade 21 has a hollow centre to reduce weight.

The air intake 17 is formed from the inner surface 22 of the housing 16 and a conical shaped disc 36, which is attached at its centre 37 to a hub member 38 and at its periphery 39 to the upper edge 40 of the turbine blade ring 35. A conical shaped member 41 is fitted aft of the conical shaped disc 36 and is attached at its centre 42 to the hub member 38 and at its periphery 43 to the lower edge 44 of the turbine blade ring 35.

The air intake 17 is divided into separate intake sections 45 by a plurality of guide vanes 46 fixed between the conical shaped disc 36 and the inner surface 22 of the housing 16. Each guide vane 46 terminates short of the turbine blade ring 35 to form an open annular normalising area 47 (FIG. 5). The airflow, having passed through the separate intake sections 45 merges again before passing through the turbine blade ring 35.

A recovery ring of turbine blades 48 is located aft of the turbine blade ring 35 and is separated therefrom by an annular chamber 49. The airflow, having passed through the turbine blade ring 35, is marshalled in the annular chamber 49 before passing through the recovery ring of turbine blades 48.

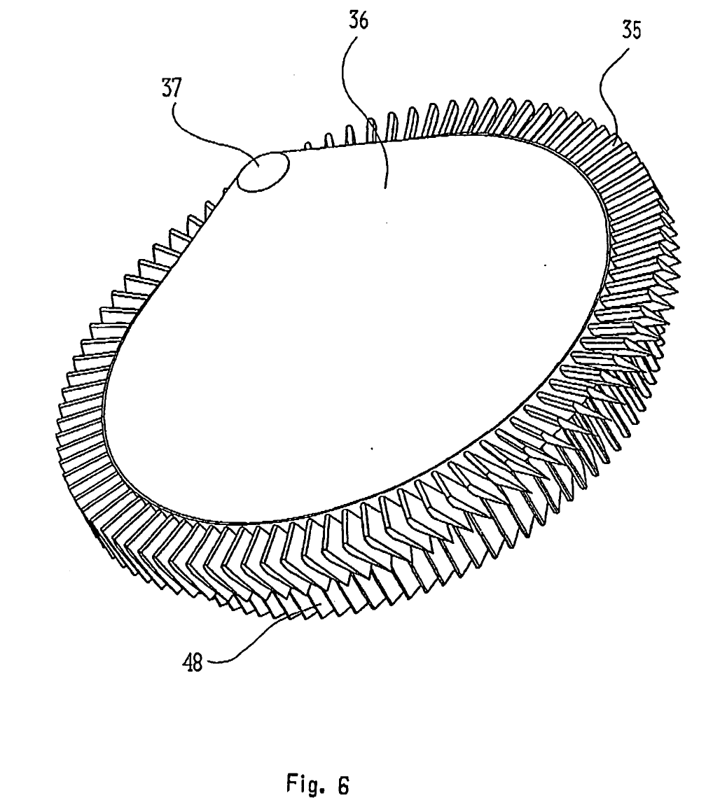

Referring to FIG. 6 the arrangement of the turbine blade ring 35 and the recovery ring of turbine blades 48 is more clearly illustrated. The turbine blade ring 35 is shown attached to the conical shaped disc 36 and the remainder of the wind turbine 11 is omitted for clarity.

In use, the airflow enters the separate air intake sections 45 and is directed towards the turbine blade ring 35 by the slope of the conical shaped disc 36, which causes the airflow to speed up. The airflow passes through the turbine blade ring 35, is marshalled in the annular chamber 49, then passes through the recovery ring of turbine blades 48 and out through the air outlet 19. At the same time, the airflow passing over the vortex generator 23 is slung out by the annular ring 33 and forms a vortex downwind of the air outlet 19. The formation of the vortex downwind of the air outlet 19 has the effect of reducing the air pressure immediately aft of the air outlet 19. This results in a speeding up of the airflow through the housing 16 with a consequent increase in the power output.

1. A wind-driven electrical power-generating device, comprising a wind turbine connected to an electrical generator, the wind turbine and generator each being mounted on a support structure, the wind turbine being in the form of a housing having an air intake at a front end and an air outlet at a rear end thereof, a plurality of turbine blades located, between the air intake and the air outlet, within the housing and fixed to an inner surface thereof, and a vortex generator arranged on an outer surface of the housing such that, in use, passage of air through the housing over the turbine blades causes the wind turbine to rotate and generate power, and such that passage of air over the vortex generator results in the generation of a vortex downwind of the air outlet.

2. A wind-driven electrical power-generating device according to claim 1, wherein the housing is in the form of a truncated cone, the base of which forms the rear end of the housing, and the vortex generator is a plurality of vanes mounted on the outer surface of the housing and set at an angle to the longitudinal axis thereof.

3. A wind-driven electrical power-generating device according to any preceding claim, wherein the outer surface of the cone adjoining the rear end of the housing is flared out to form an annular ring to which the ends of the vanes are attached.

4. A wind-driven electrical power-generating device according to any preceding claim, wherein the turbine blades are arranged in a ring.

5. A wind-driven electrical power-generating device according to claim 4, wherein the air intake is formed from the inner surface of the housing and a conical shaped disc, which is attached at its centre to a hub member and at its periphery to the turbine blade ring.

6. A wind-driven electrical power-generating device according to claim 5, wherein the air intake has a plurality of guide vanes mounted between the conical shaped disc and the inner surface of the housing to form separate intake sections.

7. A wind-driven electrical power-generating device according to claim 6, wherein the guide vanes terminate short of the turbine blade ring to form an open annular normalising area.

8. A wind-driven electrical power-generating device according to any one of claims 4 to 7, wherein a recovery ring of turbine blades is mounted aft of the turbine blade ring.

9. A wind-driven electrical power-generating device according to claim 8, wherein the turbine blade ring and the recovery ring of turbine blades are separated by an annular chamber in which the airflow, in use, is marshalled prior to it passing through the recovery ring of turbine blades.

10. A wind-driven electrical power-generating device according to any preceding claim, wherein the wind turbine and the electrical generator are mounted on the support structure with freedom of movement through 360° in the horizontal plane, such that, in use, the wind turbine locates downwind of the support structure in a self-orientating manner.

11. A wind-driven electrical power-generating device according to any preceding claim, having means for moving the wind turbine in and out of the airflow.

12. A wind-driven electrical power-generating device according to claim 11, wherein the means for moving the wind turbine moves the turbine between a position where the turbine is fully into wind and the longitudinal axis of the turbine is parallel to the wind direction, and a position where the turbine is parked and the longitudinal axis of the turbine makes an angle of between 35-50° with the wind direction.

13. A wind-driven electrical power-generating device according to claim 12, wherein the angle between the longitudinal axis of the turbine and the wind direction is 45°, when the turbine is in the parked position.

14. A wind-driven electrical power-generating device according to any one of claims 11-13, wherein the means for moving the wind turbine causes it to move in and out of the airflow in a vertical direction.

15. A wind-driven electrical power-generating device according to any one of claims 11-14, wherein the means to move the wind turbine is a hydraulic arm.

16. A wind-driven electrical power-generating device according to claim 15, wherein the hydraulic arm is under computer control.

17. A wind-driven electrical power-generating device according to claim 16, wherein the computer is linked to a wind speed sensor and a wind direction sensor, and wherein the hydraulic arm progressively moves the wind turbine towards the parked position as the wind speed increases above a safe level for operating the device in the fully into wind position.

18. A wind-driven electrical power-generating device according to claim 17, wherein the computer further monitors functions of the device including generator output, hydraulic pressure, hydraulic fluid quantity, and oil quantity and pressure.

19. A wind-driven electrical power-generating device according to any one of claims 15 to 18, having failsafe means for moving the wind turbine to the parked position in the event of a system failure.

20. A wind-driven electrical power-generating device according to claim 19, wherein the failsafe means is a blow down backup pneumatic high pressure cylinder, which, when activated, causes the hydraulic arm to move the wind turbine to the parked position.

21. A wind turbine for a wind-driven power-generating device, comprising a housing having an air intake at a front end and an air outlet at a rear end thereof, a plurality of turbine blades located between the air intake and the air outlet, within the housing and fixed to an inner surface thereof, and a vortex generator arranged on an outer surface of the housing such that, in use, passage of air through the housing over the turbine blades causes the wind turbine to rotate and generate power, and such that passage of air over the vortex generator results in the generation of a vortex downwind of the air outlet.

22. A wind turbine for a wind-driven power-generating device according to claim 21, wherein the housing is in the form of a truncated cone, the base of which forms the rear end of the housing, and the vortex generator is a plurality of vanes mounted on the outer surface of the housing and set at an angle to the longitudinal axis thereof.

23. A wind turbine for a wind-driven power-generating device according to claim 21 or 22, wherein the outer surface of the cone adjoining the rear end of the housing is flared out to form an annular ring to which the ends of the vanes are attached.

24. A wind turbine for a wind-driven power-generating device according to any of claims 21 to 23, wherein the turbine blades are arranged in a ring.

25. A wind turbine for a wind-driven power-generating device according to claim 24, wherein the air intake is formed from the inner surface of the housing and a conical shaped disc, which is attached at its centre to a hub member and at its periphery to the turbine blade ring.

26. A wind turbine for a wind-driven power-generating device according to claim 25, wherein the air intake has a plurality of guide vanes mounted between the conical shaped disc and the inner surface of the housing to form separate intake sections.

27. A wind turbine for a wind-driven power-generating device according to claim 26, wherein the guide vanes terminate short of the turbine blade ring to form an open annular normalising area.

28. A wind turbine for a wind-driven power-generating device according to any one of claims 24 to 27, wherein a recovery ring of turbine blades is mounted aft of the turbine blade ring.

29. A wind turbine for a wind-driven power-generating device according to claim 28, wherein the turbine blade ring and the recovery ring of turbine blades are separated by an annular chamber in which the airflow, in use, is marshalled prior to it passing through the recovery ring of turbine blades.

30. A wind-driven electrical power-generating device according to claim 1, substantially as hereinbefore described with particular reference to and as illustrated in FIGS. 1 and 2 of the accompanying drawings.

31. A wind turbine according to claim 21, substantially as hereinbefore, described with particular reference to and as illustrated in the accompanying drawings.
